(19) United States
(12) Patent Application Publication
(10) Pub. No.: US 2014/0368463 A1
(43) Pub. Date: Dec. 18, 2014

(54) SYSTEM AND METHOD FOR SENSOR AND IMAGE PROCESSING

(71) Applicant: STMicroelectronics (Research & Development) Limited, Marlow (GB)

(72) Inventor: Jeffrey M. Raynor, Edinburgh (GB)

(73) Assignee: STMicroelectronics (Research & Development) Limited, Marlow (GB)

(21) Appl. No.: 14/300,366

(22) Filed: Jun. 10, 2014

(30) Foreign Application Priority Data
Jun. 13, 2013 (GB) 1310500.2

(51) Int. Cl. G06F 3/041

(52) U.S. Cl. CPC G06F 3/0414
USPC 345/174

(57) ABSTRACT

A sensor for a touch screen operates to detect a touch and any associated movement thereof on the screen and determine a required control function for a device on which the touch screen is mounted. The sensor includes integrated control logic. The sensor operates to identify the existence of a feature associated with the touch and movement on the screen. The feature is processed by the logic to determine the location of the touch and any associated movement thereof on the touch screen. The feature location and any associated movement are converted by the logic into an output from which the control function can be derived by the device.

### PRIORITY CLAIM

This application claims priority from United Kingdom Application for Patent No. 1310500.2 filed Jun. 13, 2013, the disclosure of which is incorporated by reference.

### TECHNICAL FIELD

The present invention relates to a system and method for sensor and image processing, for example, for touch screen systems.

### BACKGROUND

The use of touch screen technology is becoming more and more prevalent and is being used on various different devices. There are different types of touch screens using a number of different types of technology. The various types of technology used have advantages and disadvantages depending on the particular use of the touch screen and the size of device on which it is used. Other factors, such as cost and ease of operation can also affect the type of technology adopted for a particular purpose.

A resistive touch screen is a low cost solution which uses a sandwich of two electrically-resistive, flexible membranes with an insulator layer between them. Applying pressure to the screen allows one membrane to contact the other and a potential divider is formed. By applying a voltage and measuring the output voltage, the position of the touch can be determined. This type of touch screen can be applied after manufacture of the screen and therefore is low cost. In addition, the problems of applying a cheap, but defective touch screen to an expensive system are reduced or even eliminated as the touch screen can be easily removed and replaced. Unfortunately, this technique is not suitable for multi-touch, i.e. two or more simultaneous touches, and multi-touch is a common requirement for gestures (pinch, squeeze, zoom etc.).

A capacitive touch screen is another known type of touch screen which is commonly used, as it is relatively low cost and provides multi-touch capabilities. A grid of narrow parallel conductors is formed on one plane and another grid of parallel conductors is formed on a separate, but closely spaced, plane. At the intersection a capacitance or capacitor is formed. When a finger or other object is placed near the intersection, the electric field is deformed and hence the capacitance is changed. Typically the array or capacitors is scanned and each horizontal and vertical conductor is measured sequentially. The position of the change of capacitance and therefore the position of the touch can thus be determined. This type of system is rather expensive as the conductors tend to be narrow so as to minimize optical degradation of the image, but being narrow can make the conductors susceptible to manufacturing defects. The conductors are integral to the manufacture of the screen and so any failure of the touch system means both the touch system and the display are no longer usable.

Optical Touch XY Grid touch screens are the oldest and simplest technique. In this technique a number of light sources (e.g. LEDs) are placed around two adjacent sides of a screen and a number of light sensors (e.g. photodiodes, photo-transistors or similar) are placed around the opposite sides of the screen. When a finger is placed on the screen, the light is interrupted and can be detected. This system requires many sources and sensors having complex interconnections where the detectors must be accurately placed.

A further type of optical based touch screen is the Optical Touch using imaging. This is the popular solution for large screens as it is easily scalable by using appropriate optics and for screens >10″-15″ is generally cheaper than the capacitive touch described above. The Optical Touch is also suitable for multi-touch operation. Typically, there are as many LEDs as sensors. The LEDs may be co-located with the sensor or with a small displacement. The light from the LED is reflected off a retro-reflector and returns to the sensor. In an alternative embodiment, the LED may be placed opposite the sensor and the light from the sensor passes through the sensor's imaging optics and onto the sensor's image plane. In either case, without any object on the screen, the sensor is illuminated by the light from the LED and so produces a bright image across the whole sensor. If a finger is placed on the screen, the object absorbs the light, the light beams are interrupted and so part of the sensor which generally corresponds to the location of the finger is darkened. Then by detecting this darker part of the image and determining its location on the array, the position of the finger can be accurately determined. This can be done either by using the knowledge of the optical path, such as magnification or field of view of the lens, or by calibration of the system.

In the Optical Touch as described above it is common to employ a separate controller architecture. A minimum of two sensors communicate a raw image to a controller. Sometimes the image processing is performed on a host PC or in the controller. These systems work well and are generally found on all in one machines where the monitor or display, processing and storage are in the same unit. However, they are not cost effective for other situations such as stand-alone monitors or when used on hand-held devices such as tablet devices or “E-book” readers.

In the prior-art systems, the image data is transmitted from the sensor to the separate controller. In a typical system, there are about 500 to 2 k pixels per sensor and the sensors need to operate at a relatively high frame rate such as 100 Hz to 1 kHz to avoid lag. As a result the data rate needs to be very high at about 16 Mbps.

For a large screen, there is a long distance, between about 50 cm and 1 m from the sensors to the microcontroller processing the data. Thus the transmission of high speed data is complicated and expensive shielded cables or differential signaling such as low voltage differential signaling (LVDS) are required to transmit the data in order to reduce electro-magnetic interference (EMI). This applies to signals from the touch screen interconnections into the display and also from the display into the touch screen communication data.

The differential nature of LVDS allows for cheaper, unshielded cables to be used. However as a consequence there are two times the number of connectors on the cable and also double the number of pads on the device are required. More conductors on the cable increase its size and cost. More pads on the sensor are especially disadvantageous since the pads are normally located along the short axis of the sensor and increasing the number of pads typically increases the size of the short axis. This in turn increases the die size and cost, but more importantly increases the height of the module on the screen. As device thickness is a key consumer feature a minimum size of die axis and module size is very important.

FIG. 1 shows a typical circuit for identifying the position of a finger or other pointer on the touch screen. An analog to digital converter (ADC) is inside the sensor and digital communications are passed between the sensor and the microcontroller. It is also possible to have an analog-only sensor with an analog output and an ADC in the microcontroller. This second possibility reduces the bandwidth required (1 sample per pixel instead of 8 if an 8 bit ADC is used) but at the same time increases the system's susceptibility to noise.

Ambient light cancellation is a common feature of optical touch imaging systems. Under low ambient light conditions, most of the light on the sensor is from the LED and so when a finger is placed on the screen and the beam is interrupted, the sensor becomes dark. In high ambient light levels, ambient light will illuminate a pixel irrespective of whether a finger is obstructing the LED beam or not and so hinders the detection of touches. To mitigate this, it is preferable to pulse the LED and take two images, one with the LED on and the other when it is off. The difference between the two images is determined by subtracting one from the other. Constant, or slowly changing, illumination such as ambient light is thereby cancelled out and it is much easier to detect changes of illumination due to a finger on the screen. The ambient cancellation is implemented in the host microcontroller; however this requires that both images (LED on and LED off) are transmitted from the sensor to the host microcontroller. This doubles the bandwidth required. It is therefore preferable to perform the subtraction on the sensor device as this reduces the communication bandwidth.

So called “raw video” data output is passed from the sensor to the microcontroller. This may be compressed to reduce the data rate. However, it is important that a loss-less compression technique is employed otherwise compression or decompression artifacts could be falsely interpreted as a touch and cause significant malfunction in the operating system of a touch-screen computer, such as file deletion, data loss etc. Hence, even using compression techniques, there is only a small reduction in bandwidth which can be achieved.

There are still a number of problems that have not yet been solved and addressed by the prior art. The current Optical Touch systems require multiple devices which take up space and also added cost for the original equipment manufacturer (OEM) as multiple devices must be stocked. There is still a need for a cost effective solution to implement optical touch on relatively small screens of between about 5″ and 15″.

### SUMMARY

An embodiment provides a method and system as set out in the accompanying claims.

According to one aspect there is provided a sensor for a touch screen to detect a touch and any associated movement thereof on the screen to thereby determine a required control function for a device on which the touch screen is mounted, wherein: the sensor includes integrated control logic; the sensor is capable of identifying the existence of a feature associated with the touch and/or movement on the screen; and the control logic is able to process the feature to determine the location of the touch and any associated movement thereof on the touch screen and convert the feature location and any associated movement into an output from which the control function can be derived by the device.

Optionally, the integrated logic includes a plurality of signal processing elements.

Optionally, the integrated logic comprises one or more of: an LED driver, an array of pixels, an analog to digital converter, an ambient cancellation module, a feature detection module, a touch point co-ordinate calculation module, a gesture detection module, an automatic exposure controller and general logic module, a system calibrator, a master slave selector and a USB connector.

Optionally, the feature location is determined by a feature detection module and a touch point co-ordinate calculation module.

Optionally, the feature location is determined by a feature detection module and a gesture detection module.

Optionally, one or more features are used to generate a co-ordinate or a gesture primitive.

Optionally, the co-ordinate or the gesture primitive is associated with a control function for the device and a look up table is used to find the appropriate control function.

Optionally the sensor may be used in a touch screen.

According to another aspect there is provided a device having a touch screen including the sensor of the first aspect. The device may be a telephone, a computer, a tablet, a television, a biometric sensor or any other appropriate device.

According to a further aspect there is provided a method for detecting a touch and any associated movement thereof on a touch screen, by means of a sensor including integrated control logic therein, to thereby determine a required control function for a device on which the touch screen is mounted, wherein the method comprises identifying the existence of a feature associated with the touch and/or movement on the screen; and processing the feature to determine the location of the touch and any associated movement thereof on the touch screen and convert the feature location and any associated movement into an output from which the control function can be derived by the device.

Optionally, the method may comprise determining the feature location by detecting the feature and calculating a touch point co-ordinate.

Optionally the method may comprise determining the feature location by detecting the feature and a gesture.

Optionally the method uses one or more features to generate a co-ordinate or a gesture primitive.

Optionally the method uses a look-up table to find the control function which is associated with the co-ordinate or the gesture primitive.

Embodiments herein offer a number of benefits, such as reduced bandwidth, smaller size and lower cost than previous sensors or solutions. By integrating the image processing on each of the sensors, the communication data-rate can be drastically reduced resulting in cheaper interconnects and significantly less EMI. In addition, the controller device can also be eliminated, thereby leading to further cost and space reductions. The use of gestures can be identified as well as other types of touch function and still only requires the minimum overhead in bandwidth, cost and size.

### BRIEF DESCRIPTION OF THE DRAWINGS

Reference will now be made, by way of example, to the accompanying drawings, in which:

FIG. 1 is a diagram of a prior art image processing circuit for determining touch co-ordinates;

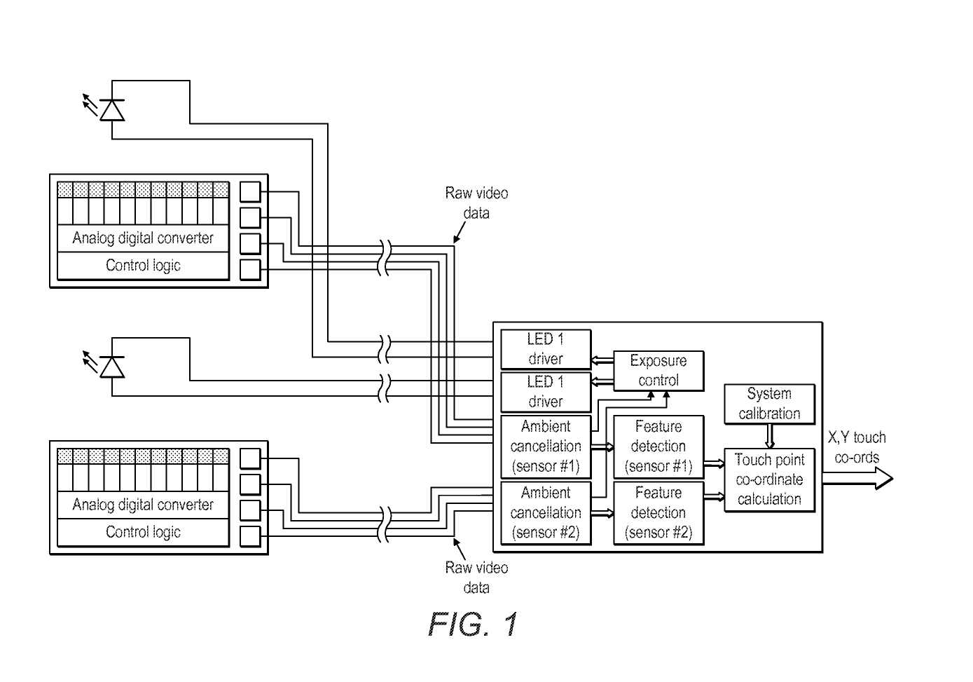

FIG. 2 is a diagram of an optical touch screen;

FIG. 3 is a diagram of a first image processing circuit for determining touch co-ordinates;

FIG. 4A is a diagram of a second image processing circuit for determining touch co-ordinates;

FIG. 4B is a diagram of third image processing circuit for determining touch co-ordinate;

FIG. 5 is a diagram of a fourth image processing circuit for determining touch co-ordinates;

FIG. 6 is a diagram of 12 tables showing gesture primitives; and

FIG. 7 is a further table for mapping gesture primitives to gestures.

### DETAILED DESCRIPTION OF THE DRAWINGS

Embodiments relate to a sensor and image processing system for an optical touch screen. An important element is to integrate control logic onto the sensor device. The control logic may include functionalities such as: exposure control, touch algorithms, etc. By doing this there is a dramatic reduction in the bandwidth required for communication, the interface is simplified leading to a reduction in cost and size.

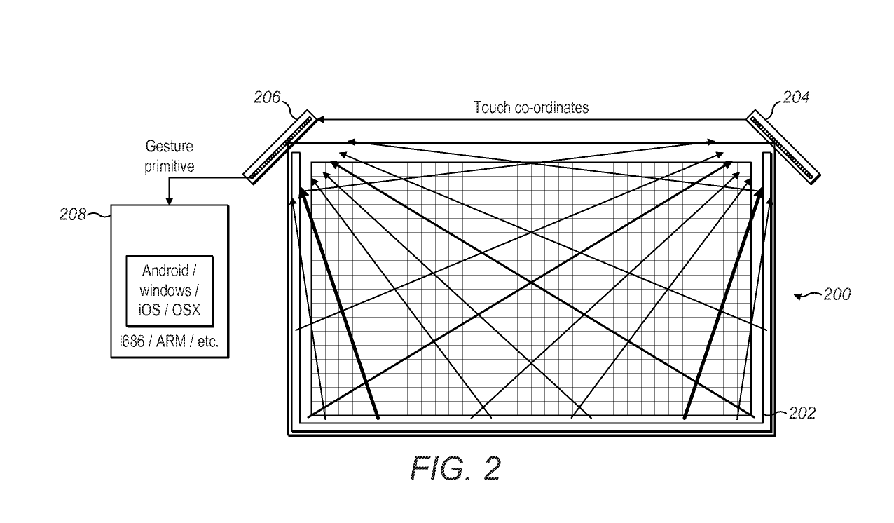

FIG. 2 shows a touch screen 200 having LEDs 202 around the edges of the screen and a right hand sensor 204 and a left hand sensor 206. The right hand sensor 204 detects the presence of a finger or any other pointer on the touch screen. The use of the term finger herein is intended to cover any type of pointer which may be used in conjunction with a touch screen. The output of the right hand sensor is passed to the master or left hand sensor. The left hand sensor generates the gesture primitives which are sent to a host system 208 and X, Y touch co-ordinates are generated as the final output as will be described below.

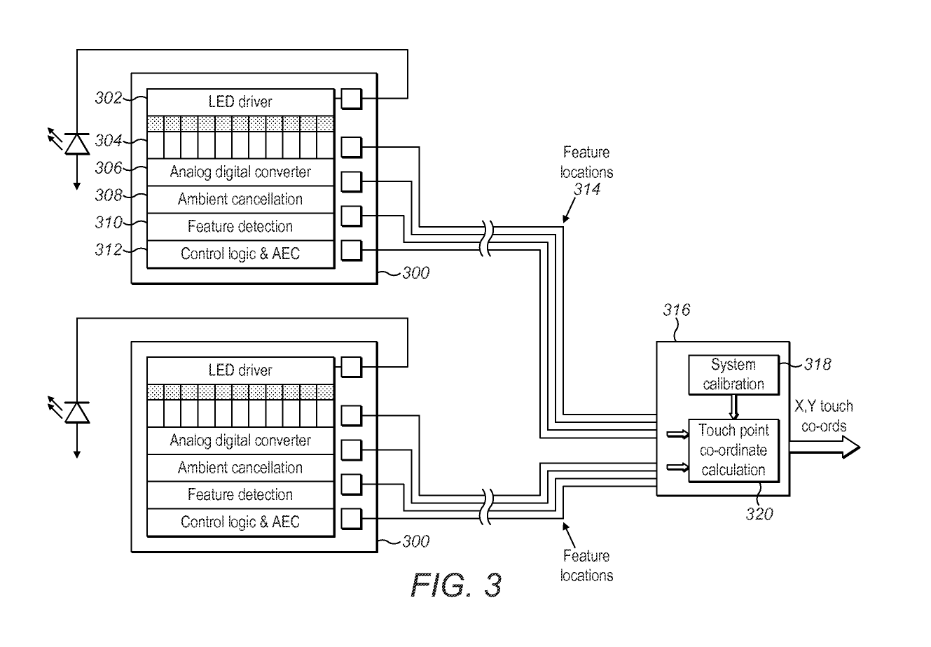

FIG. 3 shows the sensors and circuit of FIG. 2 in more detail, demonstrating an integrated feature detection on the touch screen in order to generate the touch co-ordinates. The sensors 300 each include an LED driver 302, an array of sensor elements 304, an analog to digital converter (ADC) 306, an ambient cancellation module 308, a feature detector 310 and an automatic exposure control module or controller (AEC) 312 which may also include control logic. Instead of the sensor having to output the raw data at about 16 Mpbs, it now only needs to signal the position on the sensor where the touch has occurred. For example, the pixel number of the pixel that was touched may be sent. The pixel number is determined by the feature detector 310 and a feature location 314 is output. The pixel number or feature location can be transmitted as only 9 or 10 bits of information. The pixel details could be signaled from the sensors to a microcontroller 316 using various standard communication techniques. The microprocessor may include a system calibration module 318 and a touch point co-ordinate calculator 320. These generate the X, Y touch coordinates.

One such standard communication technique is known as I2C or two wire interface. If the sensors are I2C masters, then the sensor may write to the microcontroller when a relevant event occurs. On the other hand, if the sensors are I2C slaves, then the microcontroller may continually poll or interrogate the sensor to detect and identify an event. An I2C set up may incorporate an additional connection to indicate a touch or a feature event. This connection could be shared between the sensors using for example a “wired or” logic. In this way the microcontroller could poll both sensors to see which had detected a touch event, although it is most likely that both sensors would detect a touch simultaneously.

An alternative communication technique is a Serial Peripheral Interface (SPI) which uses two, three or four wires to allow the microcontroller to continuously poll the sensors to detect any touch or touches.

The subsequent conversion from feature detections to X-Y co-ordinates could be done remotely from the sensors, either by means of a dedicated microcontroller or as part of a microcontroller elsewhere in the system.

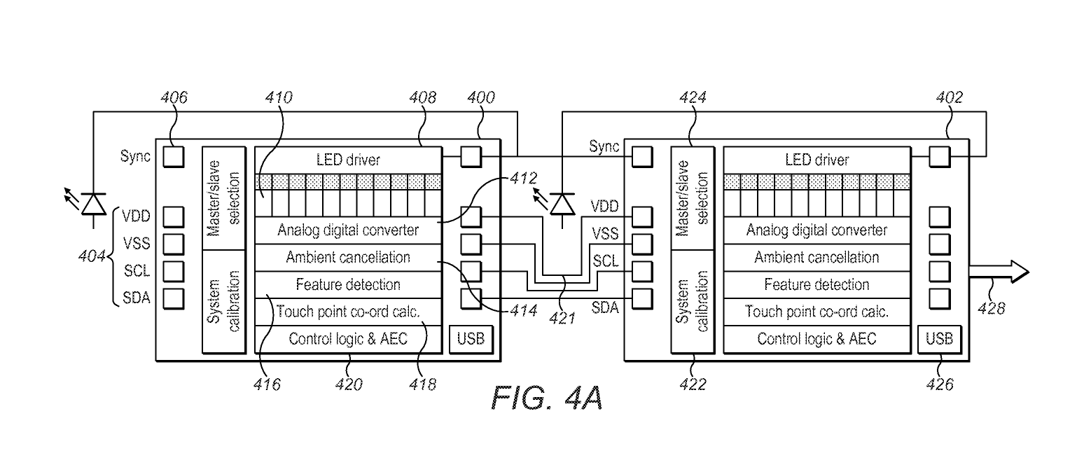

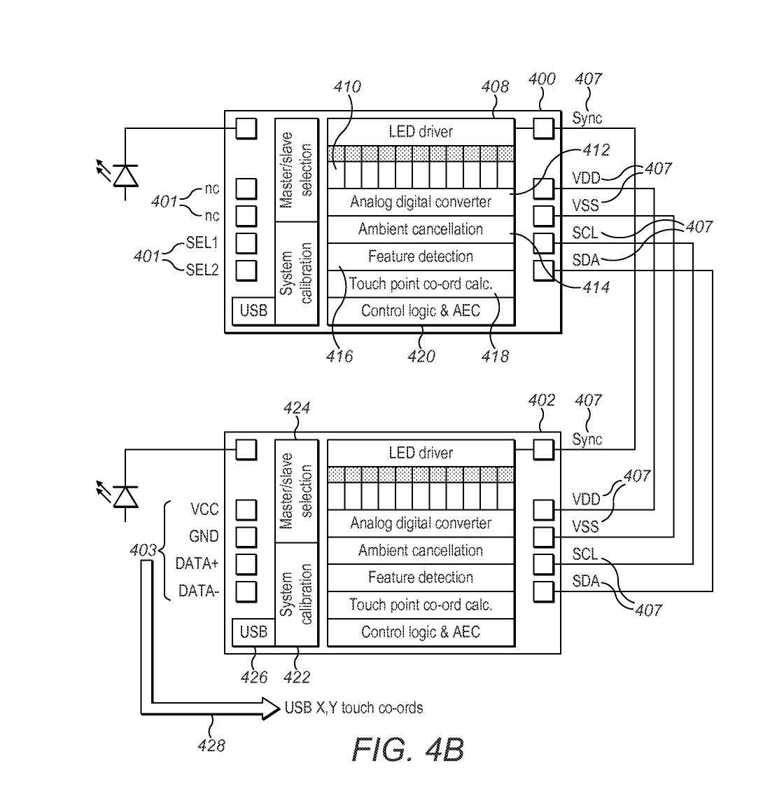

Although the implementation shown in FIG. 3 reduces the bandwidth required for the interconnections within the system, there is still a requirement for an external microcontroller. The implementation in FIG. 4A removes the need for this additional microcontroller. The FIG. 4A arrangement is referred to as a daisy-chained sensor with integrated touch algorithms. The arrangement includes a left hand side (LHS) sensor 400 and a right hand side (RHS) sensor 402. Each sensor includes the same elements. These elements include a plurality of pads on the left, one of which is a “sync pad” 406. The other pads 406 are VDD, VSS, SCL and SDA, which stand for respectively Drive voltage, a source voltage, a serial clock and serial data.

Both the LHS and RHS sensors may include some or all of the following: an LED driver 408, an array of pixels 410, an ADC 412, an ambient cancellation module 414, a feature detection module 416, a touch point co-ordinate calculation module 418, and an automatic exposure controller and general logic module 420. In addition, each sensor may also include a system calibrator 422, a master slave selector 424 and a USB connector 426.

It should be noted that in this arrangement the LHS sensor 400 may actually be on either the left or the right hand side. The pads 404 on the left side of the LHS sensor 400 are largely un-connected. The “Sync pad” 406 may be tied to a voltage or logic level, such as VSS or logic 0, to indicate that this is the first or LHS sensor of the system. The LHS sensor 400 is able to control the LEDs and can preferably signal this control to the second (RHS) sensor 402. In this way, the RHS sensor 402 can synchronize its own illumination with that of the LHS sensor 400. If optimal temporal accuracy is a requirement for a particular type of operation, the RHS sensor 402 ensures that the LED and photosensitive period is aligned with that of the LHS sensor. If peak power consumption needs to be reduced, then the RHS sensor will operate so that the LED and photosensitive period does not overlap with the LHS sensor. The measurements from the two sensors are now at different times and so a moving object will be measured at different positions by each sensor which may lead to some inaccuracy.

Also, if optical crosstalk or stray illumination is an issue, it is also possible to arrange that the LED on periods and corresponding photosensitive periods of the LHS and RHS sensors do not overlap.

As well as synchronizing the illumination, the sensors perform as described below. The LHS sensor uses its pixels, ADC, ambient cancellation, and feature detection circuits to output detected features to the RHS sensor. However, the LHS sensor does not use the system calibrator, the touch point co-ordinate calculations logic or the USB interface. The LHS sensor outputs feature locations, in a similar manner and format to that described above with respect to the FIG. 3 embodiment.

The LHS and RHS sensors have different functions. The RHS sensor is the processing master and as a consequence is most likely the exposure “slave”. This could be detected by measuring a predetermined signal, for example the voltage on the “Sync pad”. The RHS sensor uses its pixels 410, the ADC 412, the ambient cancellation module 414 and the feature detection circuit 416 to determine the location or locations of finger touch or touches. The RHS sensor then also uses the data from the LHS 421 as well as its own (RHS) features locations and the system calibration to determine the actual X, Y coordinate 428 of the touch or touches. The touch information is then signaled to the host device, through appropriate communication means, such as over I2C or in the case of a Windows 8 system, via the USB, preferably using the same pads.

The configuration in FIG. 4B demonstrates this. The pads on the right side of the die are always used for I2C (or a similar protocol such as SPI or any other) communication between the two sensors only. The sensors can still be referred to as LHS and RHS sensors 400 and 402 respectively even though they may be spatially positioned differently.

The pads on the left side of each sensor (401, 403) are used either to communicate with the host (PC or similar) via USB (or similar) or the pads are used to put one device into the “Slave” mode. For example, if the device is connected to a USB device, DATA+ and DATA− are at different voltages and the device enters “master mode”, since the device recognizes the different voltages as a predetermined signal. If the same pads are connected to the same voltage (e.g. SEL1=SEL2=VCC), the device enters “slave mode”, since the device recognizes the same voltages as a predetermined signal. The pads on the right side of the sensor (405, 407) enable the two sensors to share information such that the host can accurately determine the touch co-ordinates. It would be possible to have two sets of pads on the right side of the die, one for I2C in case the die was used as LHS and one set of pads for USB connectivity in case the die was used as RHS. However, in this embodiment there is only one set of pads on the right side of the die, which has dual functionality to operate as I2C if the die is used in LHS mode and USB if the die is used in RHS mode.

Except as indicated above, like elements have the same reference numerals as FIG. 4A and are not described in more detail here.

Typically the system derives power from the USB signal “VCC” (typically 5V). The devices may operate from a lower voltage “VDD” (e.g. 3.3V or 1.8V) and there is a suitable voltage regulator on each device. The higher voltage (VCC) may be common to both sensors and both sensors may regulate the voltage down or only the lower voltage (VDD) may be fed from one sensor to the other (as shown in FIG. 4B). In an alternative (but less preferred) situation, both supply voltages are connected to both sensors but this requires an extra conductor.

It may seem counter-intuitive to include logic modules and pads on the LHS sensor that will not be used, but there are in fact several advantages. Primarily, only one type of sensor is required for a given system, since the LHS and RHS sensors are the same even if all functions are not used in both. This will reduce the costs associated with inventory and also the costs of developing the design, masks and testing of the system. The size of the extra unused modules and unused pads is generally a very small part of the complete system so removing them and producing two different types of sensor would present little cost saving, just more design, masks and tests.

For certain systems it is important to know exactly which part of the screen is touched in order to “press” an appropriate dialogue button. This is particularly the case for Windows 8, Gnome 3 and KDE4 (an “open source desktop environment”). In other systems or applications, the user interface is generally much simpler and only gestures need to be detected, for example a “pinch and zoom”, a swipe, a scroll etc. Gestures are generally used in E-book readers, photo-frame image viewers, mobile phones, GPS navigation units and other portable electronic devices etc.

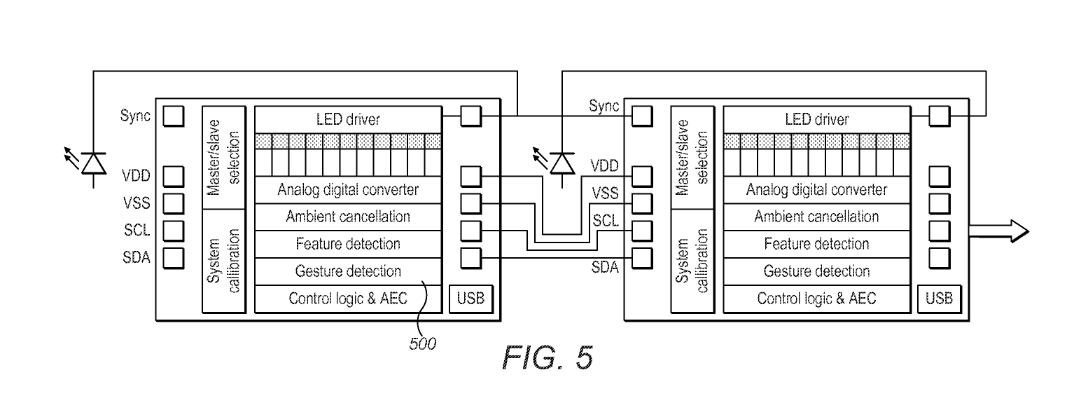

In order to identify and process gestures, the FIG. 5 embodiment, known as the daisy-chained sensor with integrated gesture detection, is proposed. The configuration of the FIG. 5 system is essentially similar to that in FIG. 4. The main difference between FIGS. 4 and 5 is the replacement of the “touch point co-ordinate calculator” by the “Gesture Detector” 500. It should be noted that both processing modules (the “touch point co-ordinate calculator” and the “Gesture Detector”) could be included in one sensor along with an appropriate switch for activating one or the other (this is not shown in the drawings).

In the previous solutions, when a touch was detected, the co-ordinate of the feature was transmitted as described above. In the FIG. 5 implementation, the movement of the touch is observed and detected. The movement is referred to as a “gesture primitive”.

Features are simple touches made on the touch screen by the finger which may take into account movement of the feature. Each feature occurs at a location which can be represented as a co-ordinate (X, Y). Certain types of movement may also constitute a feature, e.g. “stationary” “moving slowly” etc. Multiple touches and movement are more complicated features and may be referred to as gesture primitives. Gesture primitives may be used to map true gestures which in turn may be used to carry out a required control function. Co-ordinates and gesture are the output from the sensor which can then be used by the device or system to cause the control function to be carried out

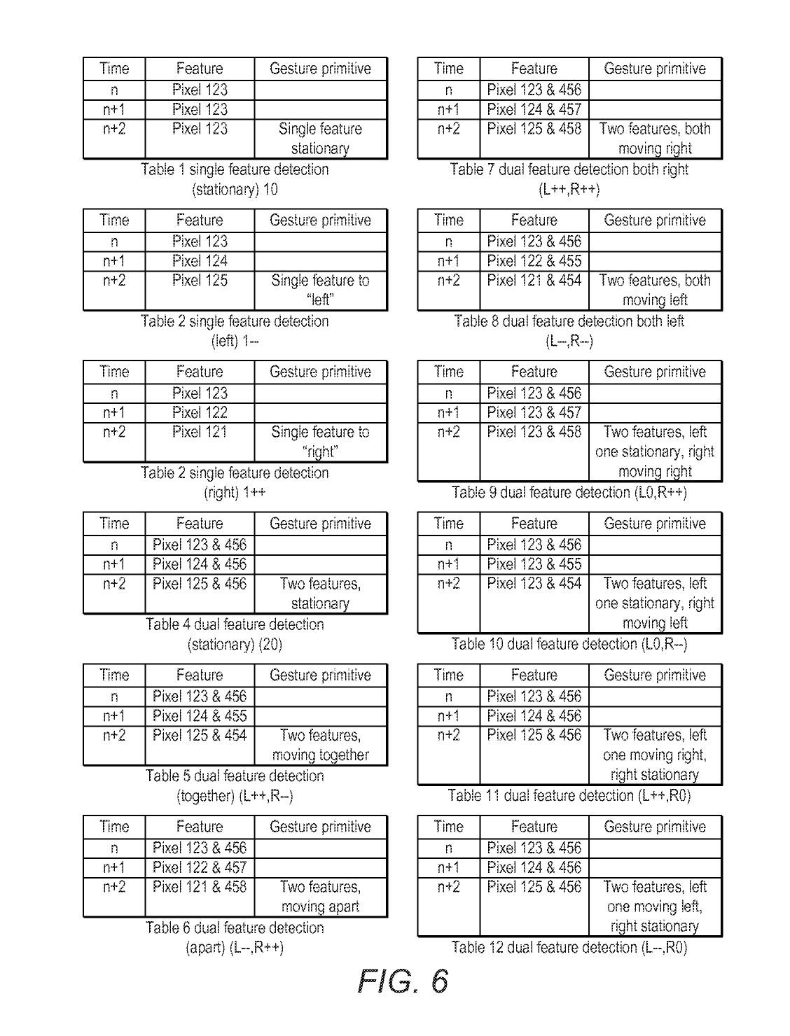

Referring now to FIG. 6, 12 example tables are shown to demonstrate the use of a feature movement at three times or frames to each represent a particular movement or gesture primitive. In practice, the number of pixels a feature has to move over or across, for a specific duration at a specific frame rate would be defined more precisely and depend on system requirements. For example, one or more registers in the sensor may be used which would allow later tuning of the pixel performance. The tuning may be carried out by changing one or more of the following attributes: integration time, gain, offset, bias conditions (voltage or current), bandwidth or slew-rate, binning mode (where the charge/signal from multiple pixels are averaged), readout mode (e.g. photo-generated charge stored on the photodiode or on a readout circuit element), etc. A hysteresis function may be added to reduce the effect of system noise or movement of the finger when it is in contact with the screen.

Table 1 shown the gesture primitive which relates to a single stationary feature detection. At all three times or frames (n, n+1 and n+2) the feature (or finger touching the screen) is always in contact with pixel 123. This means the finger has touched the screen but not moved. Table 2 shows the movement of a single feature from pixel 123, to pixel 124 and pixel 125 over the three frames. This equates to a single feature moving left. Table 3 shows a single feature moving right.

Table 4 relates to a dual feature detection. Here two features are detected at pixels 123 and 456 respectively. Neither feature moves during the three frames which equates to a dual stationary feature detection. Subsequent tables relate to different combinations of movement of two features. In some cases one feature moves and the other is stationary. Each combination of features and the associated movement (or not as the case may be) equates to a specific gesture primitive.

Each of the gesture primitives would be encoded into a value or token which is then transmitted from one sensor (e.g. LHS, the “slave” or “secondary”) to the other (e.g. RHS, the “master” or “primary”) sensor. It would also possible is to encode a “no touch” and transmit an appropriate value for this. Each gesture primitive can thus be transmitted in only 4 bits. At a slower frame rate communication is no longer required and the bandwidth required by the system is particularly low. In the Prior-art systems there are (for example) 1 k frames/sec for each of 1000 pixels which equates to 1 Mpixels/sec. With the present embodiment, not only is the amount of data reduced (a few bits of data for a gesture rather than a 1000 pixel images), but also as temporal processing or averaging is done on the sensor the reporting rate from the sensor can be slower, and be values such as 100 Hz. Combining these two conditions result in significant bandwidth reduction.

It should be noted that there could be more that two features captured in each frame and the relative movements of the various features over the time frames may each equate to a different gesture primitive. The exact combinations of gesture primitives used for a device on which the touch screen is mounted will depend on the device and the control functions required. Each gesture primitive may ultimately be associated with a control function for a specific device. There is no particular limit to the number of features and their relative movements. The tables associating detection, movement and mapping can be bespoke for a particular device or system.

An enhancement to Table 1 to Table 12 may be made, which distinguishes between “stationary” and “moving” by making use of velocity thresholds related to the movement of the feature over a chosen number of frames. In this way the gesture primitives could be distinguish between, for example, “stationary”, “moving slowly” and “moving quickly”. Although there are only a few different gesture primitives from a single sensor, combining the output from two sensors would greatly increase the functionality and may be suitable for some devices, if not others.

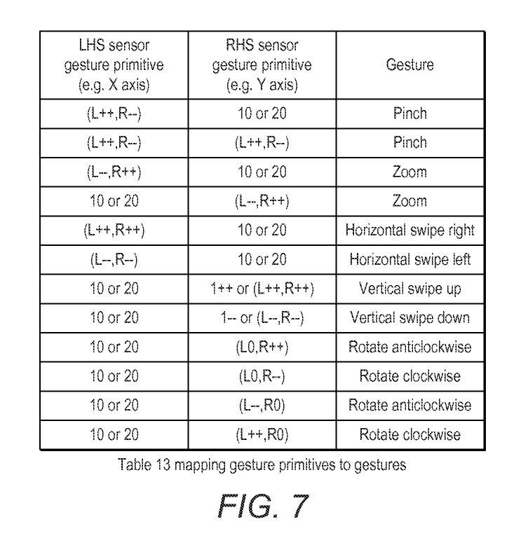

The combination of gesture primitives depends on the physical orientation of the sensors and the associated imaging system. From the gesture primitive, analysis can be carried out to identify the control gesture made by the finger. The analysis or mapping can be carried in respect of single or multiple features or gesture primitives. An example for multiple gesture primitives is shown in Table 13, FIG. 7. The LHS and RHS sensors detect gesture primitives orthogonally and a mapping of the gesture primitives to true control gestures may be carried out.

Table 13 uses only the simple “Stationary” and “Moving” gesture primitives. A more sophisticated system would use the 3 level “stationary”, “moving slowly” and “moving quickly” gesture primitives. Any combinations of gesture primitives could be used to represent an appropriate mapping to a control gesture. Gestures are generally asymmetric with respect to the X and. Y-axes as the user's finger tends to lie in a straight line, parallel to the screen's X-axis.

If the LHS and RHS sensors are not placed orthogonally, then the mapping gesture primitives to gestures would be different as there would be components of motion seen in both sensors for each feature. The table could be easily adapted to take into account different system set ups, different orientations of sensors and different combinations of features and/or gestures.

The table mapping gesture primitives to gestures could be “hard-wired” into the sensor. Alternatively, there could be multiple mapping tables on the sensor and a controller or pin wiring could be used to select which table to use. The tables could be controlled by a controller and stored in, for example, a volatile memory. This would enable the controller to update the table as required. The update could be carried out when the system is powered-on and remain constant for all operating modes, or the table could be updated in real time, for example if the screen is rotated from portrait mode to landscape mode or if different applications running on the host required different functionality. An example of this could be changing from an E-book reader to a games mode.

The sensor is of any appropriate type and may be a Complimentary Metal Oxide Semiconductor (CMOS) sensor or charge coupled device (CCD) having an array of pixels for measuring light at different locations.

The Light Source may be of any appropriate type for example LED (light emitting diode) or laser such as a VCSEL (vertical cavity surface emitting laser) and may generate a source in the “optical” or non-optical ranges. Accordingly, reference to optics and optical are intended to cover wavelengths which are not in the human visible range.

Some or all of the functions or modules could be implemented in software. It will be appreciated that the overall sensor and imaging function could be either software, hardware or any combination thereof.

The combined touch screen sensor and image processing method may be used in many different environments in an appropriate device, for example a television; a computer or other personal digital assistant (PDA); a phone; an optical pushbutton; entrance and exit systems; and any other touch screen on any other device.

It will be appreciated that there are many possible variations of elements and techniques which would fall within the scope of the present invention.

What is claimed is:

1. An apparatus, comprising:
a sensor for a touch screen configured to detect a touch and any associated movement thereof on the touch screen and to determine a required control function for a device associated with the touch screen,
wherein the sensor includes integrated control logic that is configured to identify the existence of a feature associated with touch and movement on the screen; and
wherein the integrated control logic is further configured to process the feature to determine the location of the touch and any associated movement thereof on the touch screen and convert the feature location and any associated movement into an output from which the control function can be derived by the device.

2. The apparatus of claim 1, wherein the integrated control logic includes a plurality of signal processing elements.

3. The apparatus of claim 1, wherein the integrated control logic, comprises: an LED driver, an array of pixels, and an analog to digital converter, and wherein the integrated control logic further includes one or more of: an ambient cancellation module, a feature detection module, a touch point co-ordinate calculation module, a gesture detection module, an automatic exposure controller and general logic module, a system calibrator, a master slave selector and a USB connector.

4. The apparatus of claim 1, wherein the feature location is determined by the integrated control logic using a feature detection module and a touch point co-ordinate calculation module.

5. The apparatus of claim 1, wherein the feature location is determined by the integrated control logic using a feature detection module and a gesture detection module.

6. The apparatus of claim 1, wherein one or more features are used by the integrated control logic to generate a co-ordinate or a gesture primitive.

7. The apparatus of claim 6, wherein the co-ordinate or the gesture primitive is associated with a control function for the device and a look up table is used to find the appropriate control function.

8. The apparatus of claim 1, wherein the device is a display.

9. The apparatus of claim 1, further including the touch screen coupled to the sensor.

10. The apparatus of claim 9, wherein the device is a display coupled to the touch screen.

11. An image processing circuit, comprising:
a first sensor; and
a second sensor;
wherein each of the first and second sensors comprises:
a sensor configured to detect a touch and any associated movement thereof and to determine a required control function,
wherein the sensor includes integrated control logic that is configured to identify the existence of a feature associated with touch and movement; and
wherein the integrated control logic is configured to process the feature to determine the location of the touch and any associated movement thereof and convert the feature location and any associated movement into an output from which the control function can be derived; and
wherein the integrated control logic of the first sensor is able to output its identified feature to the second sensor, and
wherein the integrated control logic of the second sensor is able to process both the identified feature of the first sensor and the identified feature of the second sensor to determine the location of the touch and any associated movement thereof and convert the feature location and any associated movement into an output from which the control function can be derived.

12. The image processing circuit of claim 11, wherein the first sensor and the second sensor each include input pads and output pads, and wherein the first sensor is daisy chained with the second sensor such that a plurality of the output pads of the first sensor are connected to a plurality of the input pads of the second sensor.

13. The image processing circuit of claim 12, wherein one or more input pads of the first sensor are adapted to identify the first sensor as a slave sensor if the signal identified at said one or more input pads is a predetermined signal.

14. The image processing circuit of claim 12, wherein one or more input pads of the second sensor are adapted to identify the second sensor as a master sensor if the signal identified at said one or more input pads is a predetermined signal.

15. The image processing circuit of claim 11, wherein the first sensor and the second sensor each include a sync pad which is able to be connected to a signal indicative of whether the sensor is a first sensor or a second sensor.

16. The image processing circuit of claim 11, wherein the first sensor and the second sensor are of the same type of sensor.

17. A method for detecting a touch and any associated movement thereof on a touch screen, by means of at least one sensor including integrated control logic therein, to thereby determine a required control function for a device on which the touch screen is mounted, wherein the method comprises:
identifying the existence of a feature associated with the touch and any associated movement on the screen; and
processing the feature to determine the location of the touch and any associated movement thereof on the touch screen and convert the feature location and any associated movement into an output from which the control function can be derived by the device.

18. The method of claim 17, further comprising determining the feature location by detecting the feature and calculating a touch point co-ordinate.

19. The method of claim 17, further comprising determining the feature location by detecting the feature and a gesture.

20. The method of claim 17, further comprising using one or more features to generate a co-ordinate or a gesture primitive.

21. The method of claim 20, further comprising using a look-up table to find the control function which is associated with the co-ordinate or the gesture primitive.

22. The method of claim 17, wherein the method uses first and second sensors including integrated control logic therein.

23. The method of claim 22, wherein the first and second sensors are arranged orthogonally.

24. The method of claim 22, wherein the method comprises
identifying with the first sensor the existence of a feature associated with the touch and any associated movement on the screen;
outputting from the first sensor to the second sensor the feature identified by the first sensor;
identifying with the second sensor the existence of a feature associated with the touch and any associated movement on the screen;
processing with the second sensor both the feature identified by the first sensor and the feature identified by the second sensor to determine the location of the touch and any associated movement thereof on the touch screen and convert the feature location and any associated movement into an output from which the control function can be derived by the device.

25. The method of claims 22, wherein the method comprises identifying the first sensor as a slave sensor if a signal identified at an input pad on the first sensor is a predetermined signal.

26. The method of claim 22, wherein the method comprises identifying the second sensor as a master sensor if a signal identified at an input pad on the second sensor is a predetermined signal.

27. The method of claim 22, wherein the method comprises identifying the first and second sensors by determining whether a signal identified at a sync pad on each of the first and second sensors is a predetermined signal.

28. The method of claim 22, wherein the first sensor and the second sensor are of the same type of sensor.
